(19) United States
(12) Patent Application Publication
(10) Pub. No.: US 2025/0167238 A1
(43) Pub. Date: May 22, 2025

(54) BIPOLAR ELECTRODE WITH ALIGNED ACTIVE LAYERS, LITHIUM ION BATTERIES HAVING SUCH ELECTRODES, AND A METHOD OF MAKING SUCH ELECTRODES

(71) Applicant: GM GLOBAL TECHNOLOGY OPERATIONS LLC, Detroit, MI (US)

(72) Inventors: Seung-Woo Chu, Sterling Heights, MI (US); Mark Daniel Gottlieb, Royal Oak, MI (US)

(21) Appl. No.: 18/515,976

(22) Filed: Nov. 21, 2023

(51) Int. Cl. H01M 4/62; H01M 4/02; H01M 4/04; H01M 4/136; H01M 4/1391; H01M 4/58; H01M 4/66; H01M 10/0525

(52) U.S. Cl. CPC H01M 4/625; H01M 4/0404; H01M 4/0435; H01M 4/136; H01M 4/1391; H01M 4/5825; H01M 4/622; H01M 4/661; H01M 10/0525; H01M 2004/021; H01M 2004/029

(57) ABSTRACT

A bipolar electrode for use in a lithium-ion battery includes a current collector, an anode having high aspect ratio conductive carbon particles and an anode binder, and a cathode having cathode active particles in a cathode binder. The high aspect ratio conductive carbon particles in the anode are aligned so that a long axis of the high aspect ratio conductive carbon particles is substantially perpendicular to the current collector. The cathode active particles are paramagnetic, diamagnetic, or magnetic and have been magnetically aligned, the cathode further comprises high aspect ratio conductive particles aligned so that a long axis of the high aspect ratio conductive particles is substantially perpendicular to the current collector, or both. The bipolar electrode can be made by subjecting the current collector coated with slurries including the components for the anode and the cathode to a magnetic field while drying.

### INTRODUCTION

The subject disclosure relates to electrodes for lithium-ion batteries and the batteries having such electrodes.

Advanced energy storage devices and systems are in demand to satisfy energy and/or power requirements for a variety of products, including automotive products such as start-stop systems (e.g., 12V start-stop systems), battery-assisted systems, Hybrid Electric Vehicles (“HEVs”), and Electric Vehicles (“EVs”). Typical lithium-ion batteries include at least two electrodes and an electrolyte and/or separator. One of the two electrodes serves as a positive electrode (or cathode) and the other electrode serves as a negative electrode (or anode). A separator and/or electrolyte may be disposed between an anode and a cathode. The electrolyte is suitable for conducting lithium ions between the electrodes. The electrolyte may be in solid, liquid, or gel form or a combination thereof. In instances of solid-state batteries, which include solid-state electrodes and a solid-state electrolyte, the solid-state electrolyte may physically separate the electrodes so that a distinct separator is not required.

Heat management can be challenging in large format cells. Internal resistance can decrease the performance of the battery. In addition, internal resistance can result in additional heat generation. Inability to manage heat can degrade performance or damage the battery or restrict the size of the battery.

### SUMMARY

In one exemplary embodiment, disclosed is a bipolar electrode for use in a lithium ion battery, wherein the bipolar electrode includes a current collector, an anode on a first side of the current collector, and a cathode on an opposite side of the current collector from the anode. The anode includes high aspect ratio conductive carbon particles and an anode binder. The high aspect ratio conductive carbon particles in the anode are aligned so that a long axis of the high aspect ratio conductive carbon particles is substantially perpendicular to the current collector. The cathode includes cathode active particles in a cathode binder, wherein (a) the cathode active particles are paramagnetic, diamagnetic, or magnetic and have been magnetically aligned, (b) the cathode further comprises high aspect ratio conductive particles aligned so that a long axis of the high aspect ratio conductive particles is substantially perpendicular to the current collector, or (c) both.

In addition, the bipolar electrode can include one or more of the features described herein.

The current collector of the bipolar electrode can include a stainless steel having a thickness of 3 to 50 microns and length and width of 10 to 100 centimeters.

The high aspect ratio conductive carbon particles of the anode of the bipolar electrode can include plate shaped particles, such as graphite flakes.

The anode of the bipolar electrode can include 90 to 97 weight percent of the high aspect ratio conductive carbon particles and 3 to 10 weight percent of the anode binder based on total weight of the anode.

The anode binder can be a carboxymethylcellulose or a styrene butadiene rubber.

The cathode active particles can include lithium transition metal phosphates, such as lithium iron phosphates.

The cathode of the bipolar electrode can include the high aspect ratio conductive particles.

The bipolar electrode can have a thickness of 100 to 300 microns.

In another exemplary embodiment, disclosed is a method of making a bipolar electrode comprising preparing a cathode slurry comprising cathode active particles, and a cathode binder in a solvent, provided that (a) the cathode active particles are paramagnetic, magnetic or diamagnetic, (b) the cathode slurry further comprises high aspect ratio conductive particles that are paramagnetic, magnetic or diamagnetic, or (c) both; coating the cathode slurry onto a first surface of a current collector; preparing an anode slurry including high aspect ratio conductive carbon particles and an anode binder in a solvent form an anode slurry; coating the anode slurry onto an opposite surface of the current collector from the cathode slurry. While drying the coatings of the anode slurry and the cathode slurry the coated current collector is subjected to a magnetic field to cause alignment of any paramagnetic cathode active particles, any high aspect ratio conductive particles, and the high aspect ratio conductive carbon particles.

In addition, the method of making a bipolar electrode can include one or more of the features described herein.

The drying of the anode slurry can occur before the coating of the cathode slurry or the drying of the cathode slurry can occur before the coating of the anode slurry. Optionally, after drying of the cathode, the cathode and current collector are calendered, the coating and drying of the anode occurs after the calendering of the cathode and current collector, and after drying the anode, the cathode, current collector and anode are calendered.

For example, after coating the cathode slurry the first surface of the current collector and coating the anode slurry to the opposite surface of the cathode slurry, and the coatings of the anode slurry and the cathode slurry can be simultaneously dried while being subjected to the magnetic field.

The method the magnetic field is from 1 to 12 Tesla and is applied for 1 to 10 minutes. The magnetic field is varied in intensity and/or direction while it is being applied to the electrode during the drying.

In another exemplary embodiment, disclosed is an electrochemical cell having one or more bipolar electrodes located between a first anode on a first anode current collector and a first cathode on a first cathode current collector. The bipolar electrode has a cathode and an anode on opposing surfaces of a third current collector. The one or more bipolar electrodes, the first anode and the first cathode are positioned such that each anode is facing and is separated from an adjacent cathode by a separator. The electrochemical cell further includes an electrolyte. The anode of the one or more bipolar electrodes includes high aspect ratio conductive carbon particles and anode binder wherein the high aspect ratio conductive carbon particles are aligned so that a long axis of the high aspect ratio conductive carbon particles is substantially perpendicular to the third current collector. The cathode of the one or more bipolar electrodes includes cathode active particles in a cathode binder wherein the cathode active particles are paramagnetic and have been magnetically aligned, the cathode further comprises high aspect ratio conductive particles aligned so that a long axis of the high aspect ratio conductive particles is substantially perpendicular to the third current collector, or both.

In addition, the electrochemical cell can include one or more of the features described herein.

The cathode active particles in the cathode of the one or more bipolar electrode can include lithium transition metal phosphates.

The first anode can also include high aspect ratio conductive carbon particles aligned so that a long axis of the high aspect ratio conductive carbon particles is substantially perpendicular to the first anode current collector. The first cathode can also include high aspect ratio comprises high aspect ratio conductive particles aligned so that a long axis of the high aspect ratio conductive particles is substantially perpendicular to the first cathode current collector, or both.

The electrochemical cell of can include at least two of the bipolar electrodes.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic side cross-sectional view of a bipolar electrode;

FIG. 2 is a schematic of a cross-sectional view of a portion of a bipolar electrode of the prior art;

FIG. 3 is a schematic of a cross-sectional view of a portion of a bipolar electrode; and

FIG. 4 is a schematic side cross-sectional view of an electrochemical cell of a battery having a bipolar electrode.

### DETAILED DESCRIPTION

The following description is merely exemplary in nature and is not intended to limit the present disclosure, its application or uses. It should be understood that throughout the drawings, corresponding reference numerals indicate like or corresponding parts and features.

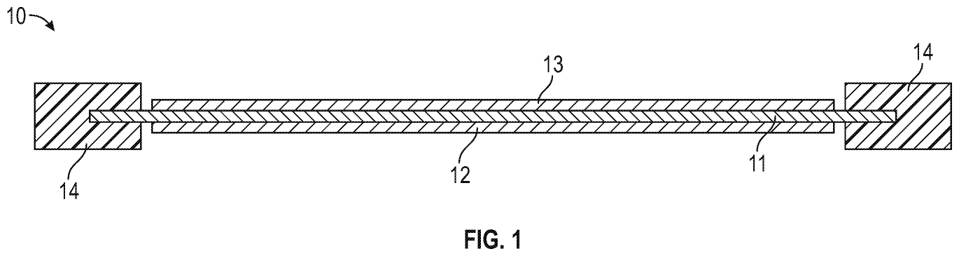

As shown in FIG. 1, a bipolar electrode 10 includes a current collector 11, an anode layer 12 on one side of the current collector 11, and a cathode layer 13 on the opposite side of the current collector 11 from the anode layer 12. In certain embodiments, the ends of the current collector may be held in place in a holder 14.

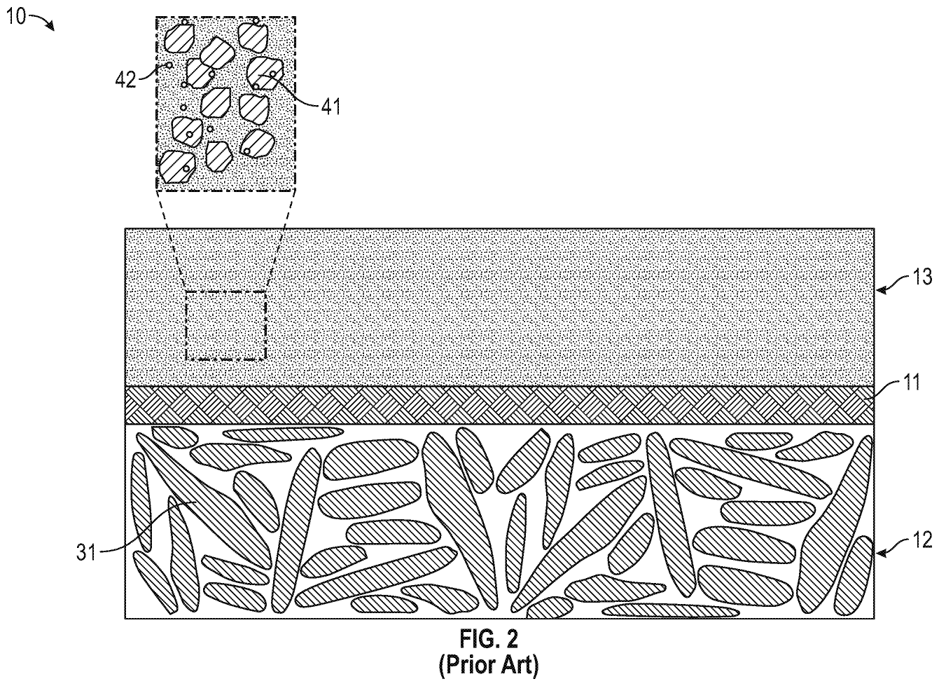

As shown in FIG. 2, according to prior art, an anode 12 of a bipolar electrode 10 can include conductive carbon particles 31 in random positioning held in place with a binder (not shown). The anode 12 can include porosity. For example, the porosity can be between about 20 to about 45 volume percent based on total volume of the anode 12. The binder provides adhesion (or cohesion) at sufficient contact points to hold the anode 12 together and to adhere the anode 12 to the current collector 11. In addition, the conductive carbon particles 31 can be in contact with at least some adjacent conductive carbon particles 31. The pores can contain an electrolyte when the bipolar electrode 10 is used in an electrochemical cell.

The cathode 13 of the bipolar electrode also includes cathode active particles 41 and conductive particles 42, which can be for example, carbon black, positioned randomly and also held in place with a binder (not shown). The cathode 13 can include porosity. For example, the porosity can be between about 20 to about 45 volume percent based on total volume of the cathode 13. The binder provides adhesion (or cohesion) at sufficient contact points to hold the cathode 13 together and to adhere the cathode 13 to the current collector 11. In addition, the cathode active particles 41 and the conductive particles 42 can be in contact with at least some adjacent cathode active particles 41 or the conductive particles 42. The pores can contain an electrolyte when the bipolar electrode 10 is used in an electrochemical cell.

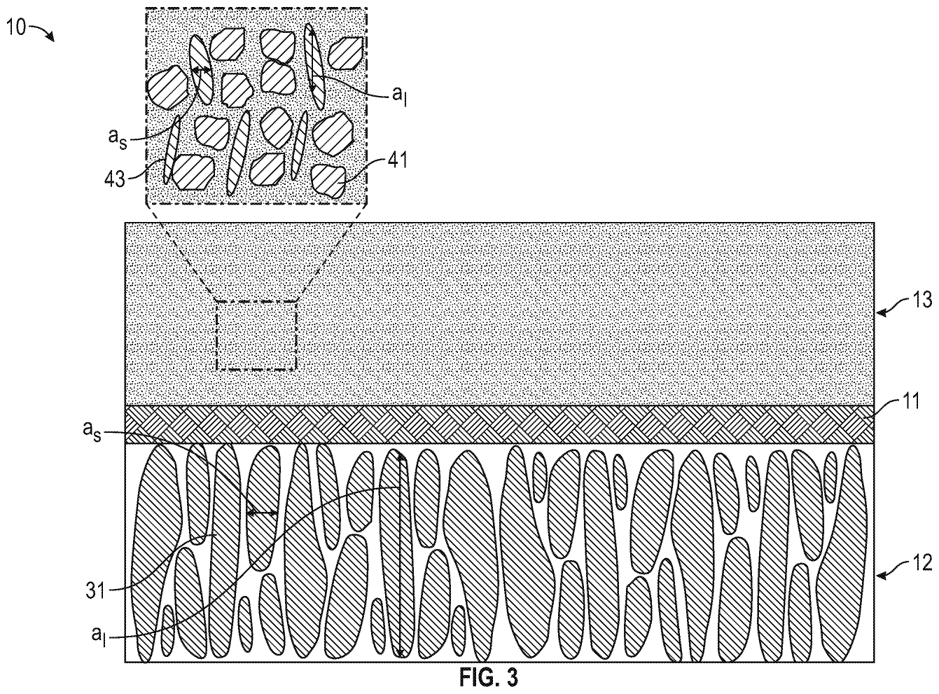

As shown in FIG. 3, (not to scale) an anode 12 of a bipolar electrode 10 includes high aspect ratio conductive carbon particles 31 held in place with a binder (not shown). The anode 12 can include porosity. For example, the porosity can be between about 20 to about 45 volume percent based on total volume of the anode 12. The binder provides adhesion (or cohesion) at sufficient contact points to hold the anode 12 together and to adhere the anode 12 to the current collector 11. In addition, the high aspect ratio conductive carbon particles 31 can be in contact with at least some adjacent high aspect ratio conductive carbon particles 31. The pores can contain an electrolyte when the bipolar electrode 10 is used in an electrochemical cell.

The cathode 13 of the bipolar electrode includes cathode active particles 41. The cathode 13 can also optionally include high aspect ratio conductive particles 43. The cathode active particles 41 and the optional high aspect ratio conductive particles 43 are held in place with a binder (not shown). The cathode 13 can include porosity. For example, the porosity can be between about 20 to about 45 volume percent based on total volume of the cathode 13. The binder provides adhesion (or cohesion) at sufficient contact points to hold the cathode 13 together and to adhere the cathode 13 to the current collector 11. In addition, the cathode active particles 41 and the optional high aspect ratio conductive particles 43 can be in contact with at least some adjacent cathode active particles 41 or the optional high aspect ratio conductive particles 43. The pores can contain an electrolyte when the bipolar electrode 10 is used in an electrochemical cell.

As shown in FIG. 3, the high aspect ratio conductive carbon particles 31, the high aspect ratio conductive particles 43, or both can be magnetic, paramagnetic or diamagnetic. The high aspect ratio conductive carbon particles 31 and 43 have a short axis, aₛ, and a long axis, aₗ. The short axis aₛ, can be orthogonal to the long axis, aₗ. The high aspect ratio conductive carbon particles 31 are aligned such that the long axis aₗ extends through the thickness of the anode 12. In other words, the high aspect ratio conductive carbon particles 31 can be aligned with a long axis a substantially perpendicular to a plane defined by the current collector 11. Similarly, the high aspect ratio conductive particles 43 have a long axis, aₗ, extending through the thickness of the cathode 13. In other words, the high aspect ratio conductive particles 43 are aligned with the long axis, aₗ, substantially perpendicular to a plane defined by the current collector 11.

The use of aligned high aspect ratio conductive carbon particles 31 and 43 can assist in ion diffusion through the anode 12 or the cathode 13 by creating more direct diffusion paths through the thickness of the anode 12 or cathode 13. This can reduce internal resistance in an electrochemical cell containing such anode 12 and/or cathode 13. The use of aligned high aspect ratio conductive carbon particles 31 and 43 can also facilitate thermal management by providing a thermally conductive path for heat transfer to the current collector 11 which is also thermally conductive.

The current collector 11 of the bipolar electrode can be a conductive metal, such as a stainless steel. The current collector can be magnetic or paramagnetic. The current collector 11 can have a thickness of, for example, from 1 or from 3, or from 5 microns up to 100, up to 80, up to 50, or up to 30 microns. The current collector can have length and width (or diameter) of greater than 1, at least 5, at least 10, at least 20 or at least n 30 up to 100, up to 50, or up to 40 centimeters.

The high aspect ratio conductive carbon particles 31 of the anode 12 can include platelet (or flake shaped) particles or needle shaped particles. For example, the high aspect ratio conductive carbon particles 31 can comprise flake shaped graphite, graphene, or carbon nanotubes. The high aspect ratio conductive carbon particles 31 can serve as an intercalation site for lithium ions as well as an electric conductor.

The platelet or flake shaped particles can have a length of a short axis, aₛ, (i.e., a thickness) of 5-100 nanometers when graphene is used, or from 0.1 or from 1 to about 5, or about 4 microns when flake shaped graphite is used. The long axis, aₗ, can be at least 3 times, at least 4 times, at least 5 times the length of the short axis, aₛ. The length of the long axis aₗ, can be up to 5000, up to 1000, up to 500, up to 100, up to 50, up to 40, up to 30, up to 20 or up to 10 times the length of the short axis, aₛ. For example, if graphene is used, the length of the long axis, aₗ, can be from 1 micron, from 2 microns, or from 3 microns up to the lesser of (a) the thickness of the anode 12 or (b) up to 25 microns, up to 20 microns, up to 15 microns, up to 10 microns. When flake shaped graphite is used the length of the long axis, aₗ, can be from 5 microns up to the lesser of (a) the thickness of the anode 12 or (b) up to 25 microns, up to 20 microns, up to 15 microns, up to 10 microns. For example, the plate-like structures can be graphene sheets or graphene sheet stacks having at least two graphene sheets stacked one on top of the other. Each graphene sheet is formed of a single layer of carbon atoms arranged in a honeycomb lattice. The graphene sheet stacks can be in the form of graphite flakes and can include greater than 10 graphene sheets or greater than 20 graphene sheets and up to 50 graphene sheets stacked one on top of the other. Alternatively, the graphene sheet stacks can be in the form of graphene nanoplatelets that have a discoid or lenticular shape and are made up of stacks of from 2 to 10 graphene sheets. The plate-like structures, such as graphene nanoplatelets, can have an aspect ratio of greater than or equal to about 20, or an aspect ratio of greater than or equal to about 100 up to 1000. The plate-like structures, such as graphene nanoplatelets, can have a porosity of about 90%. The plate-like structures, such as graphene nanoplatelets, can have a surface area in a range of from 10 m²/g to 200 m²/g. The plate-like structures, such as graphene nanoplatelets, can have an electrical conductivity measured in a direction perpendicular to a major surface thereof of about 100 Siemens per centimeter (S/cm), and an electrical conductivity measured in a direction parallel to a major surface thereof of about 107 S/cm.

The needle shaped conductive carbon particles can have an aspect ratio (length of long axis, aₗ: length of short axis, aₛ—i.e., length: diameter or length: width) of greater than or equal to about 10, greater than or equal to 50, greater than or equal to 100, or greater than or equal to about 500, greater than or equal to about 1000, and up to 5000, or up to 3000. For example, the needle-like conductive particles can include carbon nanotubes. The needle-like conductive particles, such as carbon nanotubes, can have a substantially cylindrical cross-section in a direction orthogonal to the longest dimension (length). The needle-like conductive particles, such as carbon nanotubes, can have aspect ratios (length: diameter (or length: width if not cylindrical)) of greater than or equal to about 10, greater than or equal to 50, greater than or equal to 100, or greater than or equal to about 500, greater than or equal to about 1000, and up to 5000, or up to 3000. The needle-like conductive particles, such as carbon nanotubes, can have dimensions orthogonal to the length (e.g., diameter) in a range of from 0.5 nanometers to 50 nanometers and lengths in a range of from 0.1, from 0.5, from 1, from 2, or from 3 micrometers up to 100, up to 50, up to 20, or up to 10 micrometers.

The anode 12 further includes a binder. The binder can be a polymeric material such as, for example, a polyolefin, polyvinylidene fluoride, a styrene butadiene rubber, polyurethane, or a cellulosic material such as carboxymethyl cellulose, preferably a styrene butadiene rubber or a carboxymethyl cellulose.

Optionally, the anode 12 can further include low aspect ratio conductive carbon such as carbon black in amounts of up to 5 weight percent (e.g., from 0 or from 0.5 weight percent up to 5, or up to 3 weight percent) based on total weight of the anode 12. Such low aspect ratios may be substantially spherical or may be irregular with aspect ratios of the longest dimension to the shortest dimension of 2:1 to 1:1, 1.5:1 to 1:1, or 1.2:1 to 1:1. For example, the small particles with low aspect ratio can be carbon black. The low aspect ratio particles, such as carbon black, can have an average particle diameter of from 2 nanometers up to 200, up to 150 or up to 200 nanometers. Particle size can be measured, for example, by Low Angle Laser Light Scattering (LALLS). The low aspect ratio particles can have a surface area in a range of from 10 to 500 square meters per gram (m²/g) and an electrical conductivity in a range of from 0.5 S/cm to 50 S/cm. The carbon black may be a furnace black with a surface area of approximately 45-65 m²/g in various implementations. Alternatively, the carbon black may be, for example, an acetylene black with a surface area of approximately 130-240 m²/g in various implementations. Alternatively, the carbon black may be, for example, another acetylene black with a surface area of approximately 280 to 320 m²/g in various implementations.

The anode 12 comprises from 85 or from 90 up to 98, or up to 97 weight percent of the high aspect ratio conductive carbon particles 31 based on total weight of the anode. The anode 12 can comprise from 85 or from 90 up to 98, or up to 97 weight percent of the platelet shaped conductive carbon particles 31, such as graphite flakes, based on total weight of the anode. The anode 12 comprises from 1 or from 2, or from 3 up to 15 or up to 10 weight percent of binder based on total weight of the anode.

The anode 12 can have a thickness of from 10, from 20, from 30, from 40, or from 50 up to 200, up to 150, up to 100, up to 90, up to 80, or up to 70 microns.

The cathode 13 includes cathode active particles 41. The cathode active particles 41 can include a lithium transition metal oxide, a lithium transition metal phosphate, a lithium transition metal sulfate, or a lithium transition metal silicate. According to a preferred embodiment, the cathode active particles 41 are paramagnetic, such as with a lithium iron phosphate, or diamagnetic. Lithium transition metal phosphates can be represented by the formula, LiMPO4, where M is Fe, Ni, Co, Mn, V, or a combination thereof. More specific examples of lithium transition metal phosphates include lithium iron phosphate (LiFePO4), lithium vanadium phosphate (LiVPO4), lithium manganese iron phosphate (LiMn₁₋ₓFeₓPO₄, where 0≤x≤1), and combinations thereof. The cathode active material 41 can be in the form of particles having an average particle size of from 0.5 up to 30 or up to 20 microns (i.e., mm or micrometers). Lithium transition metal phosphate particles may have average particle size of 0.5 up to 5, up to 3, or up to 2 microns. Particle size can be measured, for example, by light scattering of a solvent dispersion using as Low Angle Laser Light Scattering (LALLS) or by electron microscopy of a dry powder or coating.

The cathode 13 can preferably include high aspect ratio conductive particles 43. These high aspect ratio conductive particles are also magnetic, paramagnetic, or diamagnetic. These high aspect ratio conductive particles 43 can be platelet (or flake) shaped or needle shaped. The use of such high aspect ratio conductive particles 43 aligned with a long axis, aₗ, substantially perpendicular to the current collector 11 can facilitate in diffusion of ions by creating more direct diffusion paths through the thickness of the cathode layer can reduce internal resistance in a cell. This is particularly helpful in cathodes having cathode active material 41 with small particle sizes, such a lithium transition metal phosphates. When the cathode active particles 41 are paramagnetic, magnetic or diamagnetic, the high aspect ratio conductive particles are optional since the cathode active particles 41 themselves can be aligned to facilitate in diffusion of ions by creating more direct diffusion paths through the thickness of the cathode layer can reduce internal resistance in a cell.

The platelet or flake shaped particles can have a length of a short axis, aₛ, (i.e., a thickness) of 5-100 nanometers when graphene is used, or from 0.1 or from 1 to about 5, or about 4 microns when flake shaped graphite is used. The long axis, aₗ, can be at least 3 times, at least 4 times, at least 5 times the length of the short axis, aₛ. The length of the long axis aₗ, can be up to 5000, up to 1000, up to 500, up to 100, up to 50, up to 40, up to 30, up to 20 or up to 10 times the length of the short axis, aₛ. For example if graphene is used, the length of the long axis, aₗ, can be from 1 micron, from 2 microns, or from 3 microns up to the lesser of (a) the thickness of the anode 12 or (b) up to 25 microns, up to 20 microns, up to 15 microns, up to 10 microns. When flake shaped graphite is used the length of the long axis, aₗ, can be from 5 microns up to the lesser of (a) the thickness of the anode 12 or (b) up to 25 microns, up to 20 microns, up to 15 microns, up to 10 microns.

For example, the plate-like structures can be graphene sheets or graphene sheet stacks having at least two graphene sheets stacked one on top of the other. Each graphene sheet is formed of a single layer of carbon atoms arranged in a honeycomb lattice. The graphene sheet stacks can be in the form of graphite flakes and can include greater than 10 graphene sheets or greater than 20 graphene sheets and up to 50 graphene sheets stacked one on top of the other. Alternatively, the graphene sheet stacks can be in the form of graphene nanoplatelets that have a discoid or lenticular shape and are made up of stacks of from 2 to 10 graphene sheets. The plate-like structures, such as graphene nanoplatelets, can have an aspect ratio of greater than or equal to about 20, or an aspect ratio of greater than or equal to about 100 up to 1000. The plate-like structures, such as graphene nanoplatelets, can have a porosity of about 90%. The plate-like structures, such as graphene nanoplatelets, can have a surface area in a range of from 10 m²/g to 200 m²/g. The plate-like structures, such as graphene nanoplatelets, can have an electrical conductivity measured in a direction perpendicular to a major surface thereof of about 100 Siemens per centimeter (S/cm), and an electrical conductivity measured in a direction parallel to a major surface thereof of about 107 S/cm.

The needle shaped conductive carbon particles can have an aspect ratio (length of long axis, aₗ: length of short axis, aₛ—i.e., length: diameter or length: width) of greater than or equal to about 10, greater than or equal to 50, greater than or equal to 100, or greater than or equal to about 500, greater than or equal to about 1000, and up to 5000, or up to 3000. For example, the needle-like conductive particles can include carbon nanotubes. The needle-like conductive particles, such as carbon nanotubes, can have a substantially cylindrical cross-section in a direction orthogonal to the longest dimension (length). The needle-like conductive particles, such as carbon nanotubes, can have aspect ratios (length: diameter (or length: width if not cylindrical)) of greater than or equal to about 10, greater than or equal to 50, greater than or equal to 100, or greater than or equal to about 500, greater than or equal to about 1000, and up to 5000, or up to 3000. The needle-like conductive particles, such as carbon nanotubes, can have dimensions orthogonal to the length (e.g., diameter) in a range of from 0.5 nanometers to 50 nanometers and lengths in a range of from 0.1, from 0.5, from 1, from 2, or from 3 micrometers up to 100, up to 50, up to 20, or up to 10 micrometers.

The cathode 13 further includes a binder. The binder can be a polymeric material such as, for example, a polyolefin, polyvinylidene fluoride, polyacrylate, polytetrafluoroethylene, a styrene butadiene rubber, polyurethane, or a cellulosic material such as carboxymethyl cellulose, but is preferably polyvinylidene fluoride.

The cathode 13 can also, optionally, include low aspect ratio conductive particles such as carbon black in amounts of from 0.1, from 0.5, or from 1 up to 3 weight percent. Such low aspect ratios may be substantially spherical, or may be irregular with aspect ratios of the longest dimension to the shortest dimension of 2:1 to 1:1, 1.5:1 to 1:1, or 1.2:1 to 1:1. For example, the small particles with low aspect ratio can be carbon black. The low aspect ratio particles, such as carbon black, can have an average particle diameter of from 2 nanometers up to 200, up to 150 or up to 200 nanometers. Particle size can be measured, for example, by Low Angle Laser Light Scattering (LALLS). The low aspect ratio particles can have a surface area in a range of from 10 to 500 square meters per gram (m²/g) and an electrical conductivity in a range of from 0.5 S/cm to 50 S/cm. The carbon black may be a furnace black with a surface area of approximately 45-65 m²/g in various implementations. Alternatively, the carbon black may be, for example, an acetylene black with a surface area of approximately 130-240 m²/g in various implementations. Alternatively, the carbon black may be, for example, another acetylene black with a surface area of approximately 280 to 320 m²/g in various implementations.

The cathode 13 includes from 70, from 80, from 85, from 90, from 92, or from 95 up to 99 or up to 98 weight percent of the cathode active particles 41 based on total weight of the cathode. The cathode 13 includes 1 or from 2, or from 3 up to 30, up to 20, up to 10 or up to 5 weight percent of binder based on total weight of the cathode. Where the cathode active particles 41 are paramagnetic such that they can be aligned, the cathode 13 includes from 0 or from 0.5 up to 10, up to 5, or up to 3 weight percent of high aspect ratio conductive carbon particles 43 based on total weight of the cathode. Where the cathode active particles 41 are not paramagnetic, the cathode 13 can include from 0.5 to up to 10, up to 7 or up to 5 weight percent of high aspect ratio conductive carbon particles 43 based on total weight of the cathode.

The cathode 13 can have a thickness of 40 to 300, 50 to 200, or 60 to 150 microns.

The total thickness of the bipolar electrode 10 can be, for example, from 60 to 600, from 70 to 500, from 80 to 400, or from 100 to 300 microns.

### Method of Forming Electrode

The bipolar electrode 10 can be formed by combining the constituent components of the cathode 13 (i.e., the cathode active particles 41, optional high aspect ratio conductive particles 43, and binder) in a solvent to form a cathode slurry and coating the cathode slurry onto one surface of the current collector and combining the constituent components of the anode 12 (i.e., the high aspect ratio conductive carbon 31 and binder) in a solvent form an anode slurry and coating the anode slurry onto an opposite surface of the current collector. While drying the coating (e.g., in an oven) subjecting the structure to a strong magnetic field to cause alignment of any paramagnetic cathode active particles, any high aspect ratio conductive particles 43 and the high aspect ratio conductive carbon 31). The magnetic field can be applied before a slurry has reached a solvent content of 10% of the original solvent content to ensure that the particles are free to align. The magnetic field can be applied for example for from 1 to 10 minutes. The magnetic field can be a variable field. For example the magnetic field is varied discretely or continuously in intensity and/or direction while it is being applied to the electrode during the drying process. The magnetic field can have a strength of from 1 to 15, 2 to 13 Tesla.

The coating and subjecting to magnetic field while drying can occur sequentially for formation of first the anode and then the cathode or first the cathode and then the anode. Alternatively, both sides of the current collector can be coated and then subjected to the strong magnetic field and dried simultaneously.

Examples of solvents include water (particularly for polar or aqueous dispersible binders) or organic solvents such as N-methyl pyrrolidone (NMP). Different solvents can be used for the cathode slurry and the anode slurry or the same solvent can be used for both slurries. A viscosity of the cathode slurry and/or the anode slurry when first applied can be, for example from 1000 to 2000 centipoise (as determined by a cone and plate viscometer at a frequency of 1 kilohertz. The amount of solvent in the slurry initially can be from 40 to 70 weight percent based on total weight of the slurry. Drying can occur in an oven at, for example, 50 to 200° C. and/or under vacuum.

The dried anode and cathode layers on the current collector can be calendered. For example, the cathode slurry can be applied to the first surface of the current collector and dried under the magnetic field. After drying the cathode on the current collector can be calendered. The anode slurry can then be applied to the opposite side of the current collector and dried under magnetic field. The electrode including the cathode which had previously been calendered and the dried anode can then be calendered a second time. This can facilitate formation of high cathode density as the cathode is calendered twice. Alternatively, the electrode can be calendered a single time after both the anode and cathode have dried.

Alignment of the high aspect ratio conductive carbon particles 31 in the anode 12 and the high aspect ratio conductive particles 43 in the cathode be verified by examining a cross-section of the electrode using scanning electron microscopy (SEM).

### Electrochemical Cell

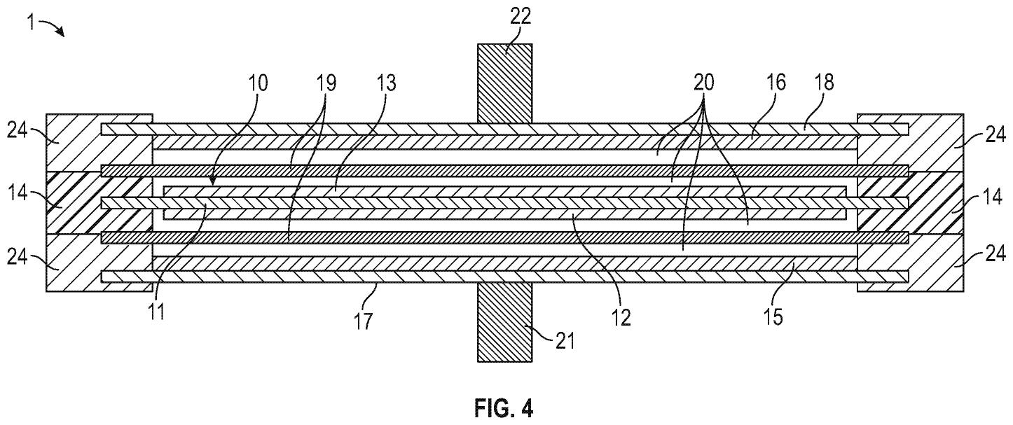

FIG. 4 shows an embodiment of an electrochemical cell 1 having bipolar electrode 10, with current collector 11, anode 12, cathode 13, and holders 14. The bipolar electrode 10 is positioned such that the anode 12 is facing a cathode 15 on a cathode current collector 17 while the cathode 13 is facing an anode 16 on an anode current collector 18. The cathode current collector 17 and anode current collector 18 may be held in place by holders 24. The anodes 12 and 16 can each be separated from their respective facing cathodes 15 and 13 by a separator 19. An electrolyte 20 is also found between the anode 12 and the cathode 15, between the anode 16 and the cathode 13, and/or infiltrating the anodes and cathodes. In another embodiment not shown the separator and electrolyte can be combined in a solid state element. A positive terminal 21 can be connected to the cathode current collector 17 and a negative terminal 22 can be connected to the anode current collector 18. While FIG. 4 shows a cell having only one bipolar electrode a cell can include two or more bipolar electrodes arranged with anode facing cathode between the cathode 15 and the anode 16. Each anode would be separated from the facing cathode by a separator and electrolyte.

The anode 16 comprises conductive carbon in a binder. The anode 16 can have a composition, a structure, or both as described herein for the anode 12. Alignment of high aspect ratio conductive particles in anode 16 is optional.

The cathode 15 can comprise cathode active particles in a binder. The cathode 15 can have a composition, a structure or both as described herein for the cathode 13.

The separator 16 can include, for example, a polymeric film, such as a polypropylene film or a coated polypropylene film.

The electrolyte 20 may include, for example, a metal salt, such as a lithium salt, dissolved in solvent(s) optionally with additional electrolyte additives. For example, the lithium salt may include lithium tetrafluoroborate (LiBF4), lithium hexafluorophosphate (LiPF6), lithium bis(flourosulfonyl)imide (LiFSI) or lithium bis(triflouromethanesolfonyl)imide (LiTFSI). The molarity can be 0.5 to 2 Molar. The solvent may include, for example, be ethyl methyl carbonate (EMC), ethylene carbonate (EC), fluoroethylene carbonate (FEC), diethyl carbonate (DEC), dimethyl carbonate (DMC), propylene carbonate (PC), polyethylene carbonate (PEC), vinyl carbonate (VC), trimethyl phosphate (TMP), sulfolane (SL), difluorobenzene (DFC), or a combination thereof. The electrolyte additive may include, for example VC, Lithium difluoro (oxalate) borate (LiDFOB), lithium diflourophosphate (LiDFP), FEC, Lithium bisoxalatoborate (LiBOB), prop-1-ene-1,3-sulfone (PES), ethylene sulfite (ES), succinonitrile (SCN), TMP, or tris (trimethylsilyl)phosphite (TMPi) or a combination thereof.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the essential scope thereof. Therefore, it is intended that the present disclosure is not limited to the particular embodiments disclosed, but will include all embodiments falling within the scope thereof.

What is claimed is:

1. A bipolar electrode for use in a lithium ion battery, wherein the bipolar electrode comprises:
a current collector;
an anode on a first side of the current collector, the anode comprising high aspect ratio conductive carbon particles and an anode binder wherein the high aspect ratio conductive carbon particles are aligned so that a long axis of the high aspect ratio conductive carbon particles is substantially perpendicular to the current collector; and
a cathode on an opposite side of the current collector from the anode, the cathode comprising cathode active particles in a cathode binder;
wherein (a) the cathode active particles are paramagnetic, diamagnetic, or magnetic and have been magnetically aligned, (b) the cathode further comprises high aspect ratio conductive particles aligned so that a long axis of the high aspect ratio conductive particles is substantially perpendicular to the current collector, or (c) both.

2. The bipolar electrode of claim 1 wherein the current collector comprises a stainless steel having a thickness of 3 to 50 microns and length and width of 10 to 100 centimeters.

3. The bipolar electrode of claim 1 wherein the high aspect ratio conductive carbon particles comprise plate shaped particles.

4. The bipolar electrode of claim 1 wherein the anode comprise 90 to 97 weight percent of the high aspect ratio conductive carbon particles and 3 to 10 weight percent of the anode binder based on total weight of the anode.

5. The bipolar electrode of claim 3 wherein plate shaped particles are graphite flakes.

6. The bipolar electrode of claim 1 wherein the anode binder is a carboxymethylcellulose or a styrene butadiene rubber.

7. The bipolar electrode of claim 1 wherein the cathode active particles comprise lithium transition metal phosphates.

8. The bipolar electrode of claim 6 wherein the cathode active particles comprise lithium iron phosphates.

9. The bipolar electrode of claim 1 wherein the cathode includes the high aspect ratio conductive particles.

10. The bipolar electrode of claim 1 having a thickness of 100 to 300 microns.

11. A method of making a bipolar electrode comprising:
preparing a cathode slurry comprising cathode active particles, and a cathode binder in a solvent, provided that (a) the cathode active particles are paramagnetic, magnetic or diamagnetic, (b) the cathode slurry further comprises high aspect ratio conductive particles that are paramagnetic, magnetic or diamagnetic, or (c) both;
coating the cathode slurry onto a first surface of a current collector;
preparing an anode slurry comprising high aspect ratio conductive carbon particles and an anode binder in a solvent form an anode slurry;
coating the anode slurry onto an opposite surface of the current collector from the cathode slurry; and
while drying the coatings of the anode slurry and the cathode slurry subjecting the coated current collector to a magnetic field to cause alignment of any paramagnetic cathode active particles, any high aspect ratio conductive particles, and the high aspect ratio conductive carbon particles.

12. The method of claim 11 wherein the drying of the anode slurry occurs before the coating of the cathode slurry or the drying of the cathode slurry occurs before the coating of the anode slurry.

13. The method of claim 11 wherein after drying of the cathode slurry, the cathode and current collector are calendered, the coating and drying of the anode occurs after the calendering of the cathode and current collector, and after drying the anode, the cathode, current collector and anode are calendered.

14. The method of claim 11 wherein coating the cathode slurry the first surface of the current collector and coating the anode slurry to the opposite surface of the cathode slurry, and then the coatings of the anode slurry and the cathode slurry are simultaneously dried while being subjected to the magnetic field.

15. The method of claim 11 wherein the magnetic field is from 1 to 12 Tesla and is applied for 1 to 10 minutes.

16. The method of claim 11 wherein the magnetic field is varied in intensity and/or direction while it is being applied to the electrode during the drying.

17. An electrochemical cell comprising one or more bipolar electrodes located between a first anode on a first anode current collector and a first cathode on a first cathode current collector, wherein the bipolar electrode has a cathode and an anode on opposing surfaces of a third current collector, wherein the one or more bipolar electrodes, the first anode and the first cathode are positioned such that each anode is facing and is separated from an adjacent cathode by a separator, wherein the electrochemical cell further comprises an electrolyte,
wherein the anode of the one or more bipolar electrodes comprises high aspect ratio conductive carbon particles and anode binder wherein the high aspect ratio conductive carbon particles are aligned so that a long axis of the high aspect ratio conductive carbon particles is substantially perpendicular to the third current collector, and
the cathode of the one or more bipolar electrodes comprises cathode active particles in a cathode binder wherein the cathode active particles are paramagnetic and have been magnetically aligned, the cathode further comprises high aspect ratio conductive particles aligned so that a long axis of the high aspect ratio conductive particles is substantially perpendicular to the third current collector, or both.

18. The electrochemical cell of claim 17 wherein the cathode active particles comprise lithium transition metal phosphates.

19. The electrochemical cell of claim 17 wherein the first anode comprises high aspect ratio conductive carbon particles aligned so that a long axis of the high aspect ratio conductive carbon particles is substantially perpendicular to the first anode current collector, the first cathode comprises high aspect ratio comprises high aspect ratio conductive particles aligned so that a long axis of the high aspect ratio conductive particles is substantially perpendicular to the first cathode current collector, or both.

20. The electrochemical cell of claim 17 comprising at least two of the bipolar electrodes.
